(19) United States
(12) Patent Application Publication
(10) Pub. No.: US 2004/0155071 A1
(43) Pub. Date: Aug. 12, 2004

(54) Push/pull closure

(76) Inventor: Phillip Higgins, Glen Waverley (AU)

Correspondence Address: MILES & STOCKBRIDGE PC, 1751 PINNACLE DRIVE, SUITE 500, MCLEAN, VA, 22102-3833, US

(21) Appl. No.: 10/472,218

(22) PCT Filed: Mar. 19, 2002
(86) PCT No.: PCT/AU02/00312

(30) Foreign Application Priority Data
Mar. 19, 2001 (AU) PR 3806

(51) Int. Cl. B67D 5/06

(52) U.S. Cl. 222/525; 222/153.14; 222/481.5

(57) ABSTRACT

A push/pull closure is disclosed the closure includes a body part (3) and a slider part (41). The slider part (41) can be moved between closed and opened positions. The body part (3) includes a nozzle section (15), a container neck engaging section (21), and an annular section (23). One feature of the closure is that the annular section (23) operates in an overcentre action to move the body part (3) from a raised position to a lowered position. As the annular section (23) moves to the lowered position the closure pierces a container membrane (7) to allow the container contents to be dispensed. Another feature of the closure is that the nozzle section (15) includes an air vent (71) that opens into a cavity (35) in which the slider part (41) slides between the open and closed positions. The air vent (71) spaced away from an outlet end (11) of the nozzle section (15) in order to minimised air entrainment as the contents of the container are being dispensed.

The present invention relates to a push/pull closure.

Push/pull closures include a body part that defines an outlet for the contents of a container and a slider part that can slide on the body part between a closed position and an open position. In the closed position the slider part closes the outlet so that the contents of the container can not be dispensed from the container via the outlet. In the open position the slider part does not close the outlet and the contents of the container can be poured from the container via the outlet.

For product integrity reasons, there is an increasing trend towards sealing food containers with a membrane seal, such as an induction or conduction foil seal, that is applied to the containers immediately after the containers are filled with a product and before closures are located on the containers. In order to obtain access to the product in such a container, it is necessary for a person to remove the closure from the container, remove the sealed membrane, and then re-locate the closure on the container. In the case of commercially available push/pull closures, this sequence of steps at the very least is an inconvenience and in many instances results in product spillage.

The first aspect of the present invention is concerned with alleviating this disadvantage of commercially available push/pull closures.

Another disadvantage of commercially available push/pull closures is that it is often the case that a partial vacuum is created as the contents are dispensed from a container that has one of these closures. The problem arises particularly in situations where a person drinks directly from the container. The partial vacuum is a consequence of limited, if any, air flow into the container via the open closure as the contents are being dispensed from the container. The partial vacuum necessitates frequent interruptions of the dispensing action to allow make-up air to enter the container in order to avoid the partial vacuum from slowing or stopping the dispensing earlier than desired.

The second aspect of the present invention is concerned with alleviating this disadvantage of commercially available push/pull closures.

According to the first aspect of the present invention there is provided a push/pull closure for a container, the container having a neck that defines an opening of the container and a seal that closes the opening and seals the container, the closure including:

(a) a body part that includes:

(i) a nozzle section that includes a passageway for dispensing the contents of the container, the nozzle section including an outlet end and a container seal piercing element;

(ii) a container neck engaging section that locates the body part on the container neck; and

(iii) an annular section having an inner margin and an outer margin, the inner margin being connected to the nozzle section and the outer margin being connected to the container neck engaging section, and the annular section being movable in an overcentre action between a raised position and a lowered position whereby, when the closure is located on the container with the seal intact and with the annular section in the raised position, movement of the annular section from the raised position to the lowered position moves the membrane piercing element downwardly and pierces the container seal; and

(b) a slider part that can slide in relation to the body part between a closed position in which the slider part closes the outlet end of the nozzle section so that in use the contents of the container can not be dispensed via the outlet end and an open position in which the slider part does not close the outlet end whereby in use the contents of the container can be dispensed via the outlet end.

Preferably the closure is a two-piece construction with the body part being one part and the slider part being the other part of the construction.

Preferably the body part is moulded in one piece from a plastics material.

Preferably the annular section of the body part is moulded in the raised position.

Preferably the annular section remains in the lowered position after being moved from the raised position to the lowered position and during subsequent movement of the slider part between the closed position and the open position.

Preferably the seal is a membrane seal.

Preferably the nozzle section includes a container seal piercing element for piercing the container seal.

Preferably the container seal piercing element includes a downwardly depending wall.

Preferably the wall is shaped so that two diametrically opposed sections of the wall contact and cut the container seal before other sections of the wall contact the container seal.

Preferably the nozzle section includes two downwardly depending prongs in board of the two cutting sections of the wall to push the cut container seal flaps downwardly.

According to the second aspect of the present invention there is also provided a push/pull closure for a container, the container having a neck that defines an opening of the container, the closure including:

(a) a body part that includes:

(i) a nozzle section that includes a passageway for dispensing the contents of the container, the nozzle section including a nozzle wall that forms the passageway, an inlet end, and an outlet end; and

(ii) a container neck engaging section that locates the body part on the container neck; and

(b) a slider part that can slide in relation to the body part between a closed position in which the slider part closes the outlet end of the nozzle section so that in use the contents of the container can not be dispensed via the outlet end and an open position in which the slider part does not close the outlet end and the contents of the container can be dispensed via the outlet end; and

the closure being characterised by an air vent for allowing air to flow into the container to balance outflow of the contents of the container via the nozzle section when the closure is located on the container and the slider part is in the open position and the contents of the container are being dispensed from the container, and the closure being further characterised by the air vent being closed when the slider part is in the closed position.

Preferably the location of the air vent is selected to minimise entrainment of air in the contents of the container as the contents are being dispensed from the container.

Preferably the nozzle section includes an annular cavity which receives a lower section of the slider part and in which the slider part slides between the closed position and the open position.

Preferably the cavity has an open upper end and a closed lower end.

Preferably the width of the cavity is selected so that the slider part is retained in the closed position at least in part by an interference fit between the slider part and walls of the body part that define the cavity.

Preferably the width of the cavity decreases with distance from the upper end so that there is an increasing interference fit as the slider part is moved from the open position to the closed position.

Preferably the nozzle section includes an outer wall and the cavity is defined by the nozzle wall and the outer wall.

Preferably the nozzle wall is cylindrical and the outer wall converges towards the lower end so that the width of the cavity decreases with distance from the upper end.

The air vent may be in a part of the nozzle wall that forms the cavity.

With this arrangement, preferably the slider part slides against the nozzle wall and thereby seals the air vent when the slider part is in the closed position.

The air vent may be in the closed lower end of the cavity.

With this arrangement, preferably the slider part seals the air vent when the slider part is in the closed position.

The closure may have more than one air vent.

Preferably the container includes a seal that closes the opening of the container and seals the container.

Preferably the seal is a membrane seal.

Preferably the nozzle section includes a container seal piercing element.

Preferably the body part includes an annular section that is connected at an inner margin to the nozzle section and at an outer margin to the container neck engaging section and is movable in an overcentre action between a raised position and a lowered position whereby, when the closure is located on the container with the seal intact and with the annular section in the raised position, movement of the annular section from the raised position to the lowered position moves the seal piercing element downwardly and pierces the container seal.

According to the present invention there is also provided, in combination, a container having a neck that defines an opening of the container and a seal that closes the opening and seals the container, and a push/pull closure in accordance with the first aspect of the invention as described above located on the container with the annular section in the raised position.

According to the present invention there is also provided, in combination, a container having a neck that defines an opening of the container, and a push/pull closure in accordance with the second aspect of the invention as described above located on the container.

The present invention is described further by way of example with reference to the accompanying drawings, of which:

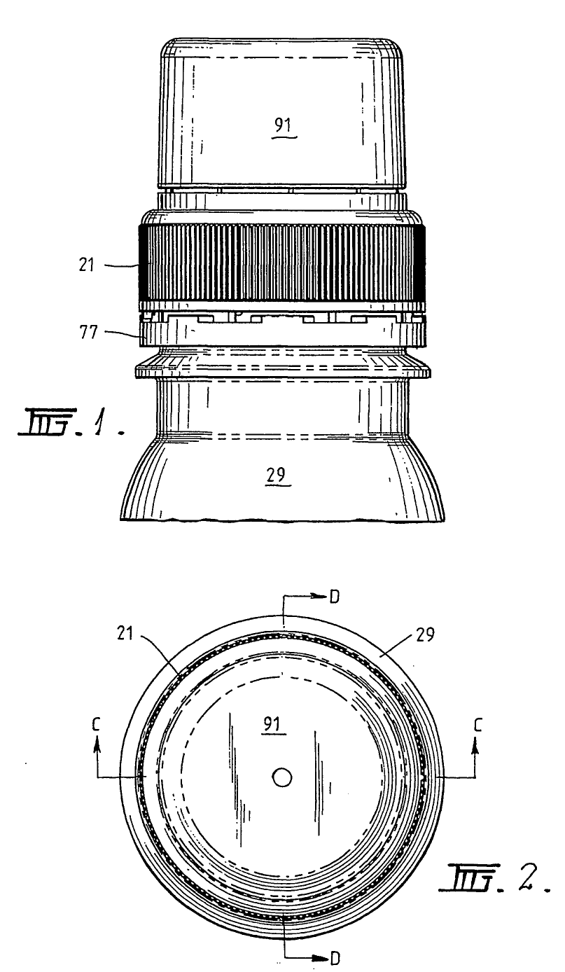

FIG. 1 is a side view of a preferred embodiment of a closure of the present invention located on a container, with the closure in a raised, closed position and the container having an intact membrane seal, and with an overcap located on the closure;

FIG. 2 is a top view of the closure/container/overcap shown in FIG. 1;

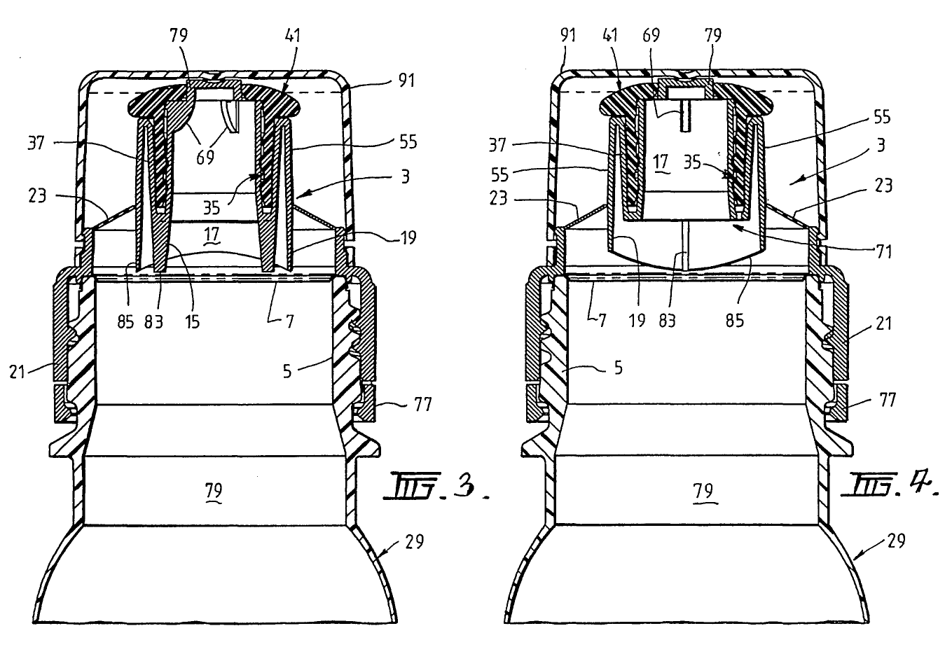

FIGS. 3 and 4 are vertical sections along the lines C-C and D-D of FIG. 2;

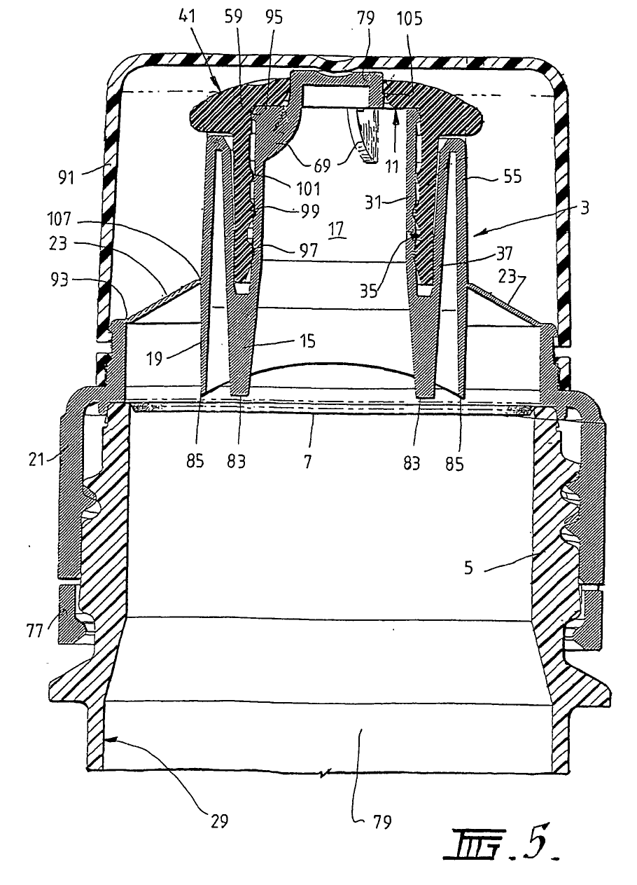

FIG. 5 is an enlargement of FIG. 3;

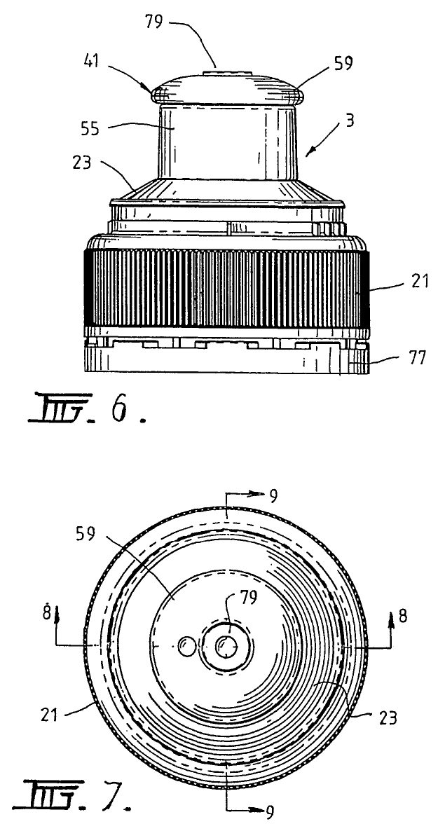

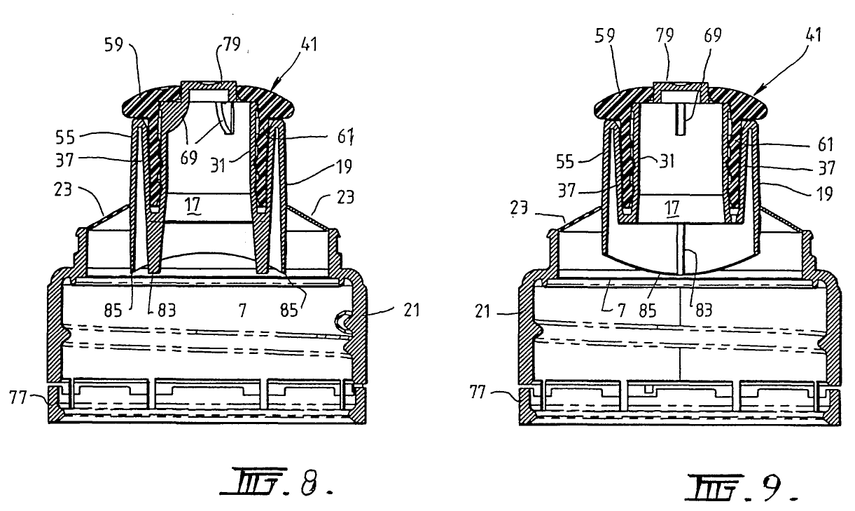

FIGS. 6 to 9 correspond to FIGS. 1 to 4, respectively, and show only the closure shown in these Figures;

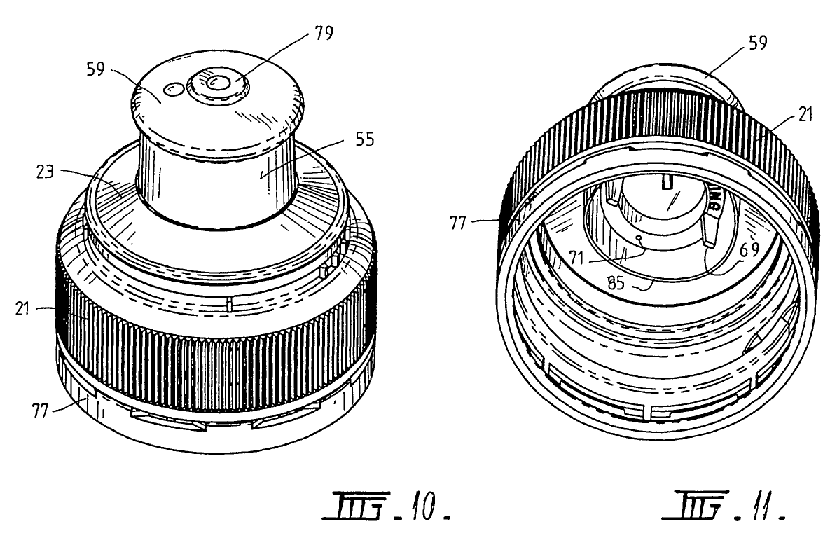

FIGS. 10 and 11 are top and underside perspective views of the closure shown in FIGS. 1 to 9;

FIG. 12 is a side view of the closure/container/overcap shown in FIGS. 1 to 11 with the closure in a lowered, closed position in which the closure pierces the membrane seal of the container;

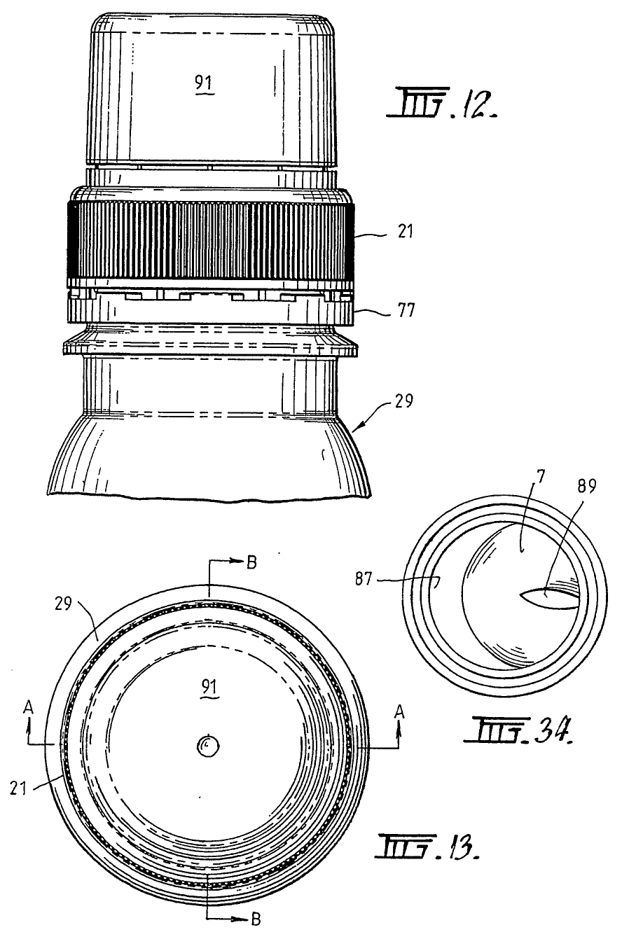

FIG. 13 is a top view of the closure/container/overcap shown in FIG. 12;

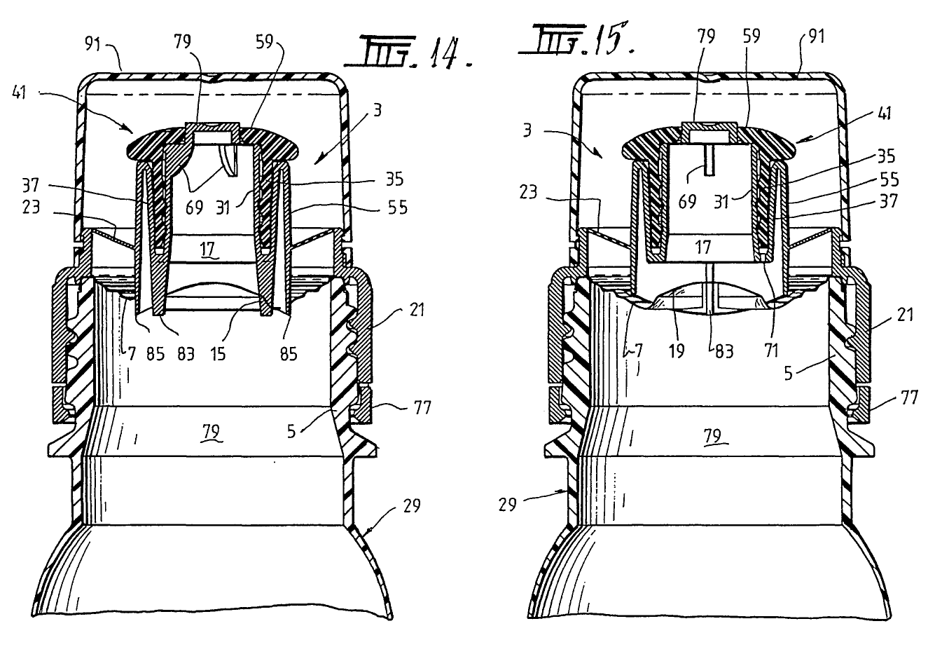

FIGS. 14 and 15 are vertical sections along the lines A-A and B-B of FIG. 13;

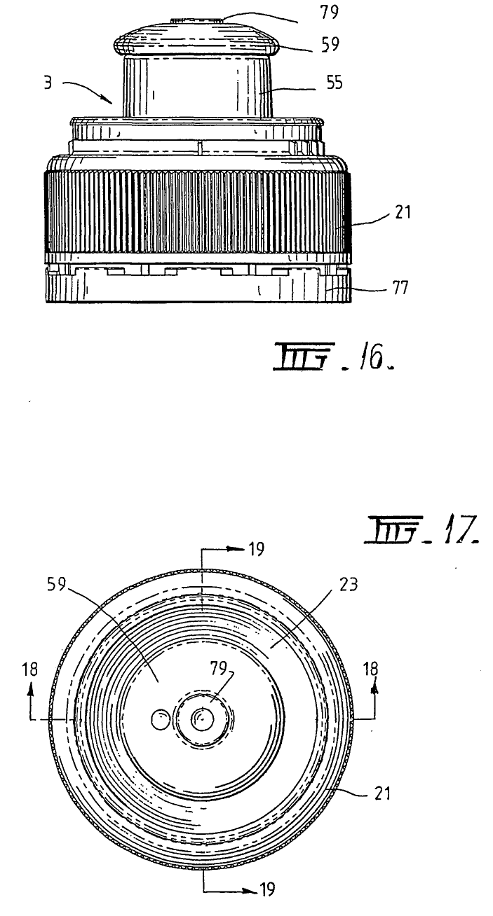

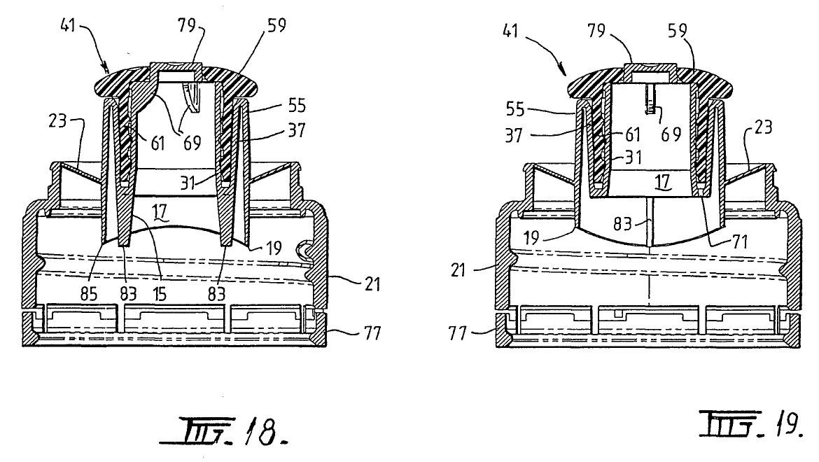

FIGS. 16 to 19 correspond to FIGS. 12 to 15, respectively and show only the closure shown in these Figures;

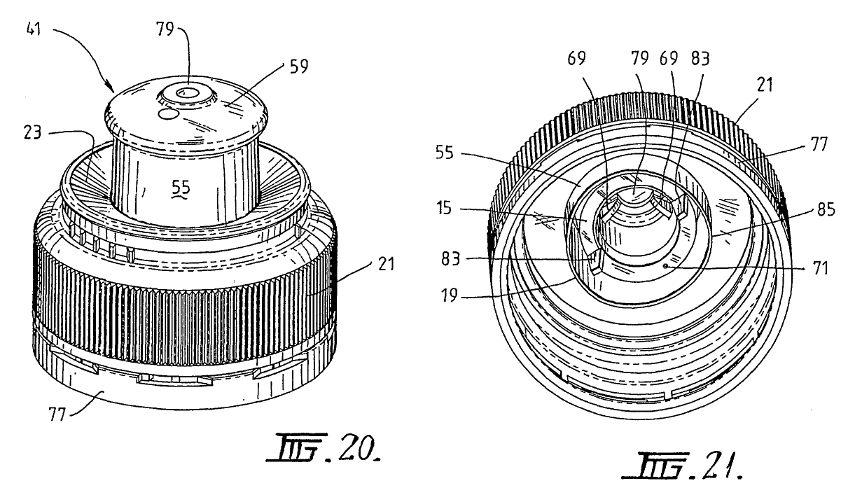

FIGS. 20 and 21 are top and underside perspective views of the closure shown in FIGS. 12 to 19;

FIG. 22 is a side view of the closure shown in FIGS. 1 to 21 with the closure in an open position;

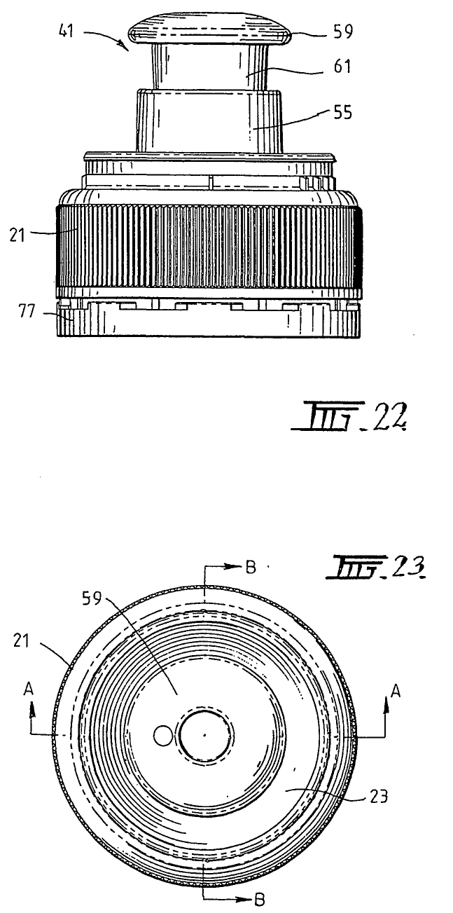

FIG. 23 is a top view of the closure/container/overcap shown in FIG. 22;

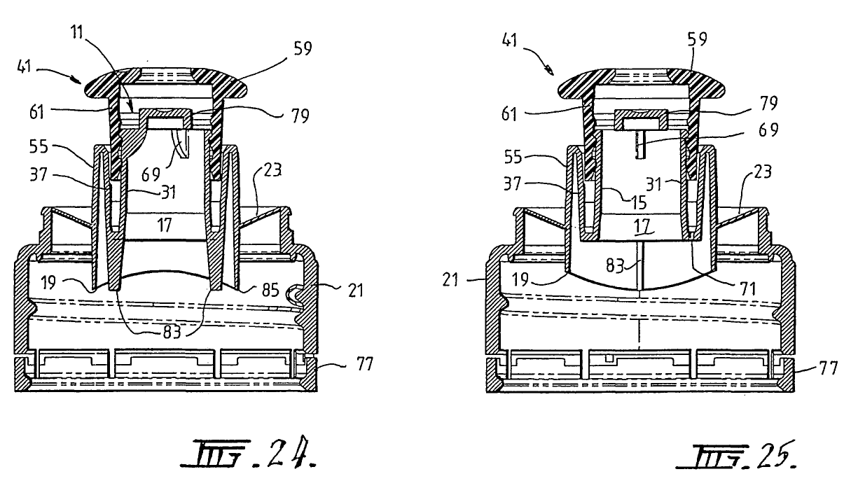

FIGS. 24 and 25 are vertical sections along the lines A-A and B-B of FIG. 23;

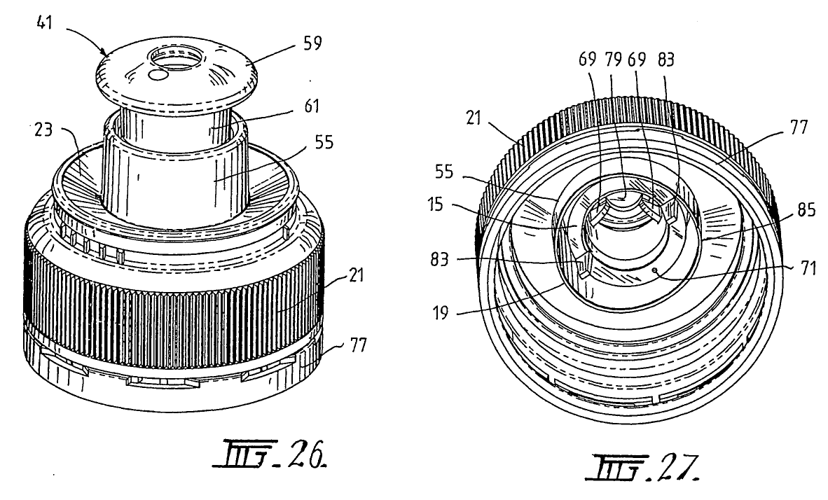

FIGS. 26 and 27 are top and underside perspective views of the closure shown in FIGS. 22 to 25;

FIG. 28 is a side view of the closure shown in FIGS. 1 to 27 at a first stage of assembling the closure in a manufacturing line;

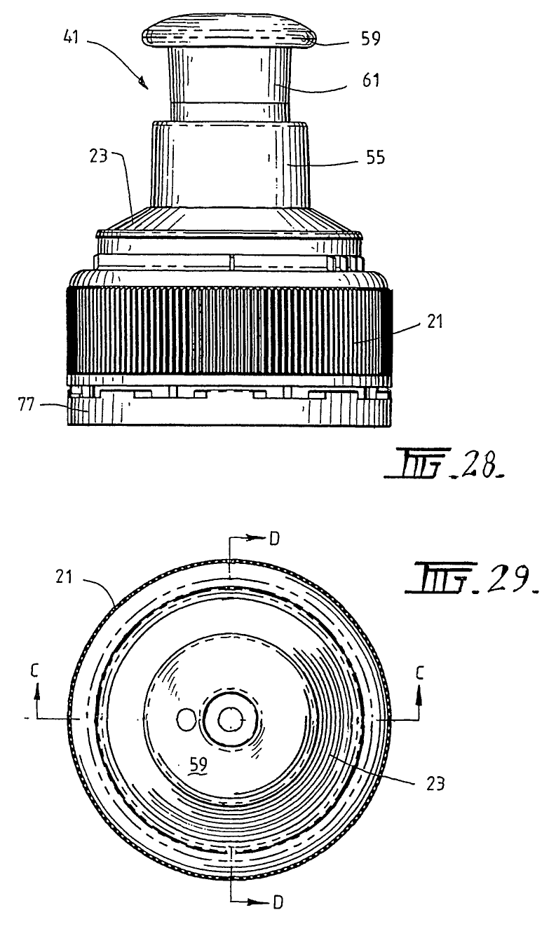

FIG. 29 is a top view of the closure shown in FIG. 28;

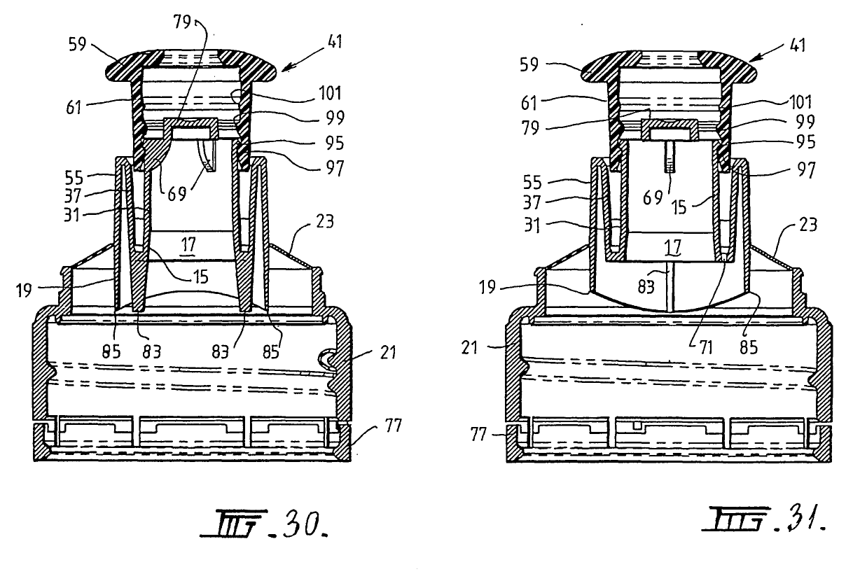

FIGS. 30 and 31 are vertical sections along the lines C-C and D-D of FIG. 29;

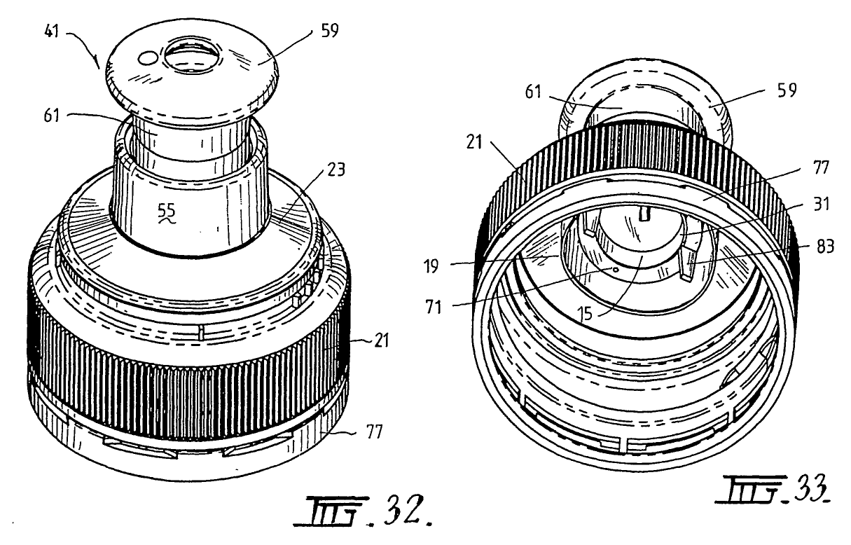

FIGS. 32 and 33 are top and underside perspective views of the closure shown in FIGS. 28 to 31; and

FIG. 34 is a top view of the container after the closure has been moved to the lowered, closed position shown in FIGS. 12 to 15 in which the closure pierces the membrane seal of the container, the Figure illustrating the configuration of the membrane seal after being pierced by the closure.

The push/pull closure shown in the Figures is adapted for use on a container 29 that has a neck 5 that defines a container opening 79 and a membrane seal 7 such as induction or conduction foil seal that is applied to the container opening after the container is filled with product and before the closure is located on the container.

The closure is also adapted to be used in conjunction with an overcap 91.

The closure incorporates the above-described first and second aspects of the invention. It is noted that the present invention is not limited to closures that incorporate both aspects of the invention and extends to arrangements in which closures incorporate one aspect only.

The closure is a two-piece construction that is injection moulded in the form shown in the Figures from a suitable plastics material.

A preferred plastics material is polyethylene. Whilst it is not usual practice to use blow moulding grade material to injection mould closure components, polyethylene is preferred in the present instance in order to provide high impact resistance.

The closure includes a body part, generally identified by the numeral 3, that defines an outlet 11 (FIGS. 5, 24 and 25) for the contents of the container and a slider part 41 that can slide on the body part 3 between a closed position of the closure (shown in FIGS. 1 to 21) and an open position of the closure (shown in FIGS. 22 to 27).

With particular reference to FIG. 5, the body part 3 includes:

(a) a nozzle section 15 that includes a central passageway 17 for dispensing the contents of the container, the nozzle section 15 including the outlet 11 (hereinafter “the outlet end 11”) and a container membrane piercing element in the form of a downwardly-depending circular wall 19 that has a sharp cutting edge that is located a short distance above the membrane seal 7 when the closure is first positioned on the container as shown in FIGS. 1 to 11;

(b) a container neck engaging section in the form of an internally-threaded skirt 21 that locates the body part 3 on the container neck 5 by engaging an external thread on the container neck 5;

(c) an annular section in the form of a membrane 23 that is connected at an inner margin to the nozzle section 15 and at an outer margin to the skirt 21 and is movable in an overcentre action between a raised position shown in FIGS. 1 to 11 and a lowered position shown in FIGS. 12 to 21; and

(d) a tamper evident band 77 connected by bridges to the lower end of the skirt 21.

It can readily be appreciated from the Figures that downward movement of the membrane 23 from the raised position shown in FIGS. 1 to 11 to the lowered position shown in FIGS. 12 to 21 moves the downwardly-depending wall 19 of the nozzle section 15 into contact with and thereafter through the membrane 7 and pierces the membrane 7.

With particular reference to FIG. 5, the connections between the outer margin of the annular membrane 23 and the skirt 21 and between the inner margin of the annular membrane 23 and the nozzle section 15 act as hinges 93, 107 that facilitates downward movement of the annular membrane 23 between the raised and the lowered positions.

With further reference to FIG. 5, the circular wall 19 that forms the piercing element of the nozzle section 15 is curved so that two diametrically opposed sections 85 of the wall are lower than the remainder of the wall. These sections 85 contact and thereby cut the membrane seal 7 before other sections of the wall 19.

In addition, the nozzle section 15 includes two diametrically opposed downwardly depending prongs 83 that are inboard of the sections 85. The prongs 83 are provided to push the cut membrane seal 7 downwardly.

In this connection, the arrangement of the cutting sections 85 and the prongs 83 is designed to (a) avoid forming fragments of the membrane seal 7 that would fall into the contents of the container; (b) avoid cutting a large disc of the membrane seal 7 that would fall into the container contents, and (c) position the cut membrane seal 7 so that it does not fold back to its original position when a person starts drinking from the container and thereby restricts or blocks altogether further dispensing of the container contents.

The applicant has found that one of the two cutting sections 85 cuts the membrane seal 7 before the other cutting section 85 and the resultant cut is larger than that made by the other cutting section 85. As a consequence, the prong 83 that is inboard of the first-to-cut cutting section 85 pushes the membrane seal 7 on that side of the container opening downwardly to a greater extent than the other prong 83 and forms a relatively larger opening 87 (FIG. 34) compared to the other (and separate) opening 89 (FIG. 34) that forms in the other side of the container.

In practice, the applicant has found that the formation of the separate openings 87, 89 in the membrane seal 7 is beneficial from the viewpoint of dispensing the contents of the container. Specifically, the applicant has found that the larger opening 87 becomes an outlet for the container contents and the separate smaller opening 89 becomes an air passageway that allows air to replace the container contents as they are removed from the container.

The annular membrane 23 and the slider part 41 are formed so that the membrane 23 remains in the lowered position shown in FIGS. 12 to 21 while the slider part 41 is moved between the closed and open positions.

As noted above, the closure includes a slider part 41 that can slide in relation to the nozzle section 15 between the closed position shown in FIGS. 1 to 21 and the open position shown in FIGS. 22 to 27.

The slider part 41 is mounted concentrically on the nozzle section 15 and is not held in position by locator rings positioned within the nozzle section 15.

With particular reference to FIG. 5, the slider part 41 includes a cylindrical side wall 61 and a top wall 59.

In the closed position shown in FIGS. 1 to 21 the slider part 41 closes the outlet end 11 of the nozzle section 15 so that the contents of the container can not be dispensed via the outlet end 11. In the open position shown in FIGS. 22 to 27 the slider part 41 does not close the outlet end 11 and the contents of the container can be discharged via the outlet end 11.

With particular reference to FIG. 5, the nozzle section 15 includes a cylindrical nozzle wall 31 that defines the passageway for dispensing the contents of the container via the outlet end 11.

The nozzle section 15 also includes an annular cavity 35 that receives the slider part 41 and in which the slider part 41 slides between the closed position and the open position of the slider part 41.

The cavity 35 has an open upper end and a closed lower end.

The cavity 35 is defined by the nozzle wall 31 and an outer wall 37 of the nozzle section 15. The outer wall 37 converges from the upper end to the lower end merges with the nozzle wall 31. With this arrangement, the width of the cavity 35 decreases with distance from the upper end. This has the effect of providing an increasing interference fit of the slider part 41 in the cavity 35 as the slider part 41 is being moved to the closed position and this serves to assist in retaining the slider part 41 in the closed position.

Other factors that contribute to retaining the slider part 41 in the closed position are the contact pressure of the slider part 41 against the nozzle wall 31 and the contact pressure of the top wall 59 of the slider part 41 against the end piece 79 of the nozzle section 15.

With reference to FIGS. 4, 15, 19, 21, 25 and 27, the closure further includes an air vent 71 located in the closed end of the cavity 35 of the nozzle section 15.

The purpose of the air vent 71 is to allow air to flow into the container to balance outflow of the contents of the container via the nozzle section 15 when the slider part 41 is in the open position and the contents of the container are being dispensed from the container.

The position of the air vent 71 is selected so that the air vent 71 is open when the slider part 41 is in the open position shown in FIGS. 22 to 27 and is closed when the slider part 41 is in the closed position shown in FIGS. 1 to 27. The latter consideration is important in order to prevent leakage of the contents of the container when the closure is closed.

The position of the air vent 71 is also selected so that the air vent 71 is as far away as possible from the outlet end 11 of the nozzle section 15 in order to minimise entrainment of air in the contents being dispensed via the passageway and the outlet end 11.

With particular reference to FIG. 5, the side wall 61 of the slider part 41 contacts and slides against the outer surface of the nozzle wall 31. Specifically, the side wall 61 includes 3 inwardly extending circumferential beads 97, 99, 101 that contact and slide against the outer surface of the nozzle wall 33.

In addition, the side wall 61 includes an upper outer retaining bead or lip 95.

With further reference to FIG. 5, the lower bead 97 seals the air vent 71 when the slider part 41 is in the closed position shown in FIGS. 1 to 21. In addition, the lower bead 97 co-operates with the upper lip 95 when the slider 41 and the body part 3 are assembled together in a high speed manufacturing line. The initial assembly of these two parts is illustrated in FIGS. 28 to 32.

The intermediate bead 99 co-operates with the upper lip 95 to prevent removal of the slider part 41 from the nozzle section 15 when the slider part 41 is in the open position. Specifically, upward movement of the slider part 41 brings the intermediate bead 99 into contact with the upper lip 95, and the upper lip 95 prevents further upward movement of the slider part 41.

The upper bead 101 prevents downward movement of the slider 41 when the slider 41 is in the open position shown in FIGS. 22 to 27 and a person is drinking from the container. Specifically, the upper bead 101 is spaced upwardly from the intermediate bead 99 whereby when the intermediate bead 99 contacts the slider part 41 the upper bead 101 is above the upper lip 95. In this position, the upper lip 95 provides resistance to downward movement of the slider part 41.

The nozzle section 15 also includes a button-shaped end piece 79 and a series of bridges 69 that interconnect the end piece 79 and the nozzle wall 31 and locate the end piece 79 centrally in the outlet end 11. As a consequence, the outlet end 11 is in the form of an annular gap or gaps interrupted by a series of bridges between the end piece 79 and the nozzle wall 31.

With particular reference to FIG. 5, the top wall 59 of the slider part 41 closes the outlet end 11 when the slider part 41 is in the closed position shown in the Figure. The top wall 59 has a central opening that is formed so that the top wall 59 can fit over the end piece 79 and form a seal between the end piece 79 and the top wall 59.

With further reference to FIG. 5, the end piece 79 includes an upwardly facing shoulder 105 on the side wall of the end piece 79. The applicant has found that the shoulder 105 improves the seal between the end piece 79 and the top wall 59.

The nozzle section 15 also includes an outer cylindrical side wall 55 that forms a downwardly depending outer sleeve of the nozzle sections. An upper end of the sleeve 55 is connected to an upper end of the outer wall 37 and a lower end of the sleeve 55 is the part of the nozzle section 15 that is connected to the inner margin of the annular membrane 7 via the hinge 107.

The sleeve 55 is formed as a downwardly depending member so that it can flex inwardly. Specifically, the applicant has found that the sleeve 55 can flex inwardly in response to downward movement of the annular membrane 23 and that this inward flexing movement significantly reduces the stresses acting on the hinge 107 during the movement.

The downwardly-depending cutting wall 19 is an extension of the sleeve 55.

The above-described closure is an effective means of piercing a container that is closed by a membrane seal without having to remove the closure from the container to gain access to the membrane. In addition, the closure and more particularly the vent hole 79 is an effective means of overcoming the partial vacuum problem of commercially available push/pull closures.

Many modifications may be made to the preferred embodiment of the closure of the present invention described above without departing from the spirit and scope of the invention.

1. A push/pull closure for a container, the container having a neck that defines an opening of the container and a seal that closes the opening and seals the container, the closure including:
(a) a body part that includes:
(i) a nozzle section that includes a passageway for dispensing the contents of the container, the nozzle section including an outlet end and a container seal piercing element;
(ii) a container neck engaging section that locates the body part on the container neck; and
(iii) an annular section having an inner margin and an outer margin, the inner margin being connected to the nozzle section and the outer margin being connected to the container neck engaging section, and the annular section being movable in an overcentre action between a raised position and a lowered position whereby, when the closure is located on the container with the seal intact and with the annular section in the raised position, movement of the annular section from the raised position to the lowered position moves the membrane piercing element downwardly and pierces the container seal; and
(b) a slider part that can slide in relation to the body part between a closed position in which the slider part closes the outlet end of the nozzle section so that in use the contents of the container can not be dispensed via the outlet end and an open position in which the slider part does not close the outlet end whereby in use the contents of the container can be dispensed via the outlet end.

2. The closure defined in claim 1 wherein the closure is a two-piece construction with the body part being one part and the slider part being the other part of the construction.

3. The closure defined in claim 2 wherein the body part is moulded in one piece from a plastics material.

4. The closure defined in claim 3 wherein the annular section of the body part is moulded in the raised position.

5. The closure defined in claim 1 wherein the annular section of the body part remains in the lowered position after being moved from the raised position to the lowered position and during subsequent movement of the slider part between the closed position and the open position.

6. The closure defined in any one of the preceding claims wherein the container seal is a membrane seal.

7. The closure defined in any one of the preceding claims wherein the nozzle section includes a container seal piercing element for piercing the container seal.

8. The closure defined in claim 7 wherein the container seal piercing element includes a downwardly depending wall.

9. The closure defined in claim 8 wherein the wall is shaped so that two diametrically opposed sections of the wall contact and cut the container seal before other sections of the wall contact the container seal.

10. The closure defined in claim 9 wherein the nozzle section includes two downwardly depending prongs in board of the two cutting sections of the wall to push the cut container seal flaps downwardly.

11. A push/pull closure for a container, the container having a neck that defines an opening of the container, the closure including:
(a) a body part that includes:
(i) a nozzle section that includes a passageway for dispensing the contents of the container, the nozzle section including a nozzle wall that forms the passageway, an inlet end, and an outlet end; and
(ii) a container neck engaging section that locates the body part on the container neck; and
(b) a slider part that can slide in relation to the body part between a closed position in which the slider part closes the outlet end of the nozzle section so that in use the contents of the container can not be dispensed via the outlet end and an open position in which the slider part does not close the outlet end and the contents of the container can be dispensed via the outlet end; and
the closure being characterised by an air vent for allowing air to flow into the container to balance outflow of the contents of the container via the nozzle section when the closure is located on the container and the slider part is in the open position and the contents of the container are being dispensed from the container, and the closure being further characterised by the air vent being closed when the slider part is in the closed position.

12. The closure defined in claim 11 wherein the location of the air vent is selected to minimise entrainment of air in the contents of the container as the contents are being dispensed from the container.

13. The closure defined in claim 11 or claim 12 wherein the nozzle section includes an annular cavity which receives a lower section of the slider part and in which the slider part slides between the closed position and the open position.

14. The closure defined in claim 13 wherein the cavity has an open upper end and a closed lower end.

15. The closure defined in claim 13 or claim 14 wherein the width of the cavity is selected so that the slider part is retained in the closed position at least in part by an interference fit between the slider part and walls of the body part that define the cavity.

16. The closure defined in any one of claims 13 to 15 wherein the width of the cavity decreases with distance from the upper end so that there is an increasing interference fit as the slider part is moved from the open position to the closed position.

17. The closure defined in any one of claims 13 to 16 wherein the nozzle section includes an outer wall and the cavity is defined by the nozzle wall and the outer wall.

18. The closure defined in claim 17 wherein the nozzle wall is cylindrical and the outer wall converges towards the lower end so that the width of the cavity decreases with distance from the upper end.

19. The closure defined in any one of claims 13 to 18 wherein the air vent is in a part of the nozzle wall that defines the cavity.

20. The closure defined in claim 19 wherein the slider part slides against the nozzle wall and thereby seals the air vent when the slider part is in the closed position.

21. The closure defined in any one of claims 13 to 18 wherein the air vent is in the closed lower end of the cavity.

22. The closure defined in claim 21 wherein the slider part seals the air vent when the slider part is in the closed position.

23. The closure defined in any one of claims 11 to 22 wherein the nozzle section includes a container seal piercing element for piercing a seal that closes the opening of the container.

24. The closure defined in claim 23 wherein the container seal piercing element includes a downwardly depending wall.

25. The closure defined in claim 24 wherein the wall is shaped so that two diametrically opposed sections of the wall contact and cut the container seal before other sections of the wall contact the container seal.

26. The closure defined in claim 25 wherein the nozzle section includes two downwardly depending prongs in board of the two cutting sections of the wall to push the cut container seal flaps downwardly.

27. The closure defined in any one of claims 11 to 26 wherein the body part includes an annular section having an inner margin and an outer margin, the inner margin being connected to the nozzle section and the outer margin being connected to the container neck engaging section, and the annular section being movable in an overcentre action between a raised position and a lowered position whereby, when the closure is located on the container with the seal intact and with the annular section in the raised position, movement of the annular section from the raised position to the lowered position moves the seal piercing element downwardly and pierces the container seal.

28. In combination, a container having a neck that defines an opening of the container and a seal that closes the opening and seals the container, and a push/pull closure defined in any one of claims 1 to 6 located on the container with the annular section in the raised position.

29. In combination, a container having a neck that defines an opening of the container, and a push/pull closure defined in any one of claims 7 to 20 located on the container.
